(19) United States
(12) Patent Application Publication
(10) Pub. No.: US 2020/0325718 A1
(43) Pub. Date: Oct. 15, 2020

(54) QUICK EXHAUST DEVICE

(71) Applicant: Line Technics Co., Ltd., Ansan-si (KR)

(72) Inventor: Tae Whan YEA, Yongin-si (KR)

(73) Assignee: Line Technics Co., Ltd., Ansan-si (KR)

(21) Appl. No.: 16/811,566

(22) Filed: Mar. 6, 2020

(30) Foreign Application Priority Data
Apr. 10, 2019 (KR) 10-2019-0042152

(51) Int. Cl. E05F 15/53

(52) U.S. Cl. CPC E05F 15/53; E05Y 2201/454; E05Y 2900/148; E05Y 2201/626; E05Y 2201/456

(57) ABSTRACT

The present invention provides a quick exhaust device including: a first rod fixed at one end thereof to an inner lower portion or an inner intermediate portion of the exhaust window and mounted at the other end thereof so as to be upwardly inclined in a direction of being directed toward the inner surface of the exhaust window; a piston rod hingedly fixed at an upper end thereof to the other end of the first rod so as to be directed upwardly; a cylinder coupled to a lower portion of the piston rod so as to be directed upwardly to allow the piston rod to be withdrawn upwardly from the cylinder; and a first bracket fixed at one end thereof to the inner side of the wall at a lower portion of the exhaust port and hingedly fixed at the other end thereof to a lower portion of the cylinder.

### CROSS-REFERENCE TO RELATED APPLICATIONS

This application claims the benefit of Korean Patent Application No. 10-2019-0042152, filed on Apr. 10, 2019 in the Korean Intellectual Property Office, which is incorporated herein by reference in its entirety.

### BACKGROUND OF THE INVENTION

### 1. Field of the Invention

The present invention relates to a quick exhaust device configured to be opened or closed in a quick and automatic manner to exhaust indoor air.

### 2. Description of Related Art

An exhaust window is installed to exhaust indoor air of an equipment room to the outside for the purpose of ventilating the equipment room that houses various kinds of mechanical or electrical/electronic devices. Disposed on a wall of an equipment room or the like, is an exhaust port for exhausting indoor air of the equipment room and an opening/closing door for opening/closing the exhaust port.

In most cases, the exhaust window is disposed at an upper portion of the wall and has a structure in which it is opened at the upper portion thereof to the outside, making it not easy for a worker to open the exhaust window in every case and leading to a risk of safety accidents.

In order to solve such a problem, an example of an opening/closing device of an exhaust window has been disclosed in Korean Patent Laid-Open Publication No. 10-2004-0095066 (entitled “Automatic Opening/Closing Device of Ventilation Window for Factory”)

The opening/closing device is characterized in that a ventilation window 1 is installed at a predetermined position of a fixed window frame 2 in such a manner that a hinge 3 is formed at a rear upper portion of the ventilation window 1 so as to be freely rotatably attached to the fixed window frame 2, in that a rotary bracket 4 is mounted to a front surface of the fixed window frame 2 so that a rotating arm 6 disposed at an upper portion of a pneumatic cylinder 5 is axially installed at the rotary bracket 4, and a piston rod 7 disposed at a lower portion of the pneumatic cylinder 5 is rotatably coupled to a rotary bracket 4a mounted to an intermediate frame 1a of the ventilation window 1, in that the pneumatic cylinder 5 includes a pneumatic pressure supply part 5a formed at an upper portion of one side thereof to allow a pneumatic pressure to be supplied thereto through the pneumatic pressure supply part and a pneumatic pressure discharge part 5b formed at a lower portion of the one side thereof to allow the pneumatic pressure to be discharged therefrom through the pneumatic pressure discharge part so that hose lines 8a and 8b are connected to the pneumatic pressure supply part 5a and the pneumatic pressure discharge part 5b, respectively, so as to be connected to a pneumatic solenoid valve 9 installed at a position which a worker's hands reach above the ground, and in that a pneumatic line 8 of an air compressor (not shown) is connected to an underside of the pneumatic solenoid valve 9 and a manipulation lever 10 is mounted on the pneumatic solenoid valve 9.

The opening/closing device has a structure in which the ventilation window 1 hingedly fixed to the piston rod 7 by withdrawing the piston rod 7 from the pneumatic cylinder 5 hingedly fixed to the fixed window frame 2. However, the opening/closing device has a disadvantage in that an overload is applied to the pneumatic cylinder 5 at an initial driving stage and thus the opening/closing device is not operated smoothly. In addition, when an angle between the pneumatic cylinder 5 and the ventilation window 1 is set to be large (i.e., the length of the rotary bracket 4a mounted to the intermediate frame 1a of the ventilation window 1 is set to be long, the opening/closing operation of the ventilation window is smoothly performed. To this end, one side of the pneumatic cylinder 5 hingedly fixed to the fixed window frame 2 is required to be protruded largely from the fixed window frame 2. Thus, an operation space required for opening/closing the ventilation window 1 is increased, disadvantageously resulting in a limitation in the installation space of the opening/closing device. Further, the conventional opening/closing device entails a problem in that since the length of the rotary bracket 4a mounted to the intermediate frame 1a of the ventilation window 1 is short, the opening/closing angle of the ventilation window 1 relative to the fixed window frame 2 by the piston rod 7 withdrawn from the pneumatic cylinder 5 is decreased.

### SUMMARY OF THE INVENTION

Accordingly, the present invention has been made to solve the aforementioned problems occurring in the prior art, and it is an object of the present invention to provide a quick exhaust device that can prevent an overload from being applied to a cylinder at an initial driving stage, can smoothly be operated, and requires a reduced installation space.

To achieve the above object, the present invention provides a quick exhaust device configured to automatically open/close an exhaust window in a vertically swivellable manner, the exhaust window being hingedly fixed to an upper portion of an exhaust port disposed on a wall, the exhaust device including: a first rod fixed at one end thereof to an inner lower portion or an inner intermediate portion of the exhaust window and mounted at the other end thereof so as to be upwardly inclined in a direction of being directed toward the inner surface of the exhaust window; a piston rod hingedly fixed at an upper end thereof to the other end of the first rod so as to be directed upwardly; a cylinder coupled to a lower portion of the piston rod so as to be directed upwardly to allow the piston rod to be withdrawn upwardly from the cylinder, wherein the cylinder is configured to allow the piston rod to be inserted thereinto so that the other end of the first rod to which the upper end of the piston rod is hingedly fixed is downwardly swiveled by being pulled downwardly to outwardly push the inner lower portion of the exhaust window to which the one end of the first rod is fixed to thereby open the exhaust window, and the cylinder is configured to allow the piston rod to be withdrawn therefrom so that the other end of the first rod to which the upper end of the piston rod is hingedly fixed is upwardly swiveled by being pushed upwardly to inwardly pull the inner lower portion of the exhaust window to which the one end of the first rod is fixed to thereby close the exhaust window; and a first bracket fixed at one end thereof to the inner side of the wall positioned at a lower portion of the exhaust port and hingedly fixed at the other end thereof to a lower portion of the cylinder.

In addition, the quick exhaust device of the present invention may further include a second rod fixed at one end thereof to an inner upper portion of the exhaust window in such a manner as to be positioned higher than a position of the exhaust window, where the one end of the first rod is fixed, and fixed at the other end thereof to an intermediate portion of the first rod.

Further, the quick exhaust device of the present invention may further include: a rotating pin formed extending outwardly from a hinged fixing part where the upper end of the piston rod is hingedly fixed to the other end of the first rod; and a rotating pin guide plate fixed to one side of the exhaust port and having a first arcuate elongated hole formed in a shape the same as that of a swiveling trajectory of the first rod according to the withdrawal or insertion of the piston rod from or into the cylinder to allow the rotating pin to be inserted into the first arcuate elongated hole to guide the rotating pin along the swiveling trajectory of the first rod.

Moreover, a roller may be disposed at an insertion portion of the rotating pin 115 inserted into the first elongated hole 161.

### Effects of the Invention

The quick exhaust device according to the present invention as constructed above has an advantage in that the first rod 110 that is installed inclinedly is pulled downwardly or pushed upwardly by the insertion or withdrawal of the piston rod 120 into or from the cylinder 130 to open or close the exhaust window, so that an overload is not applied to the cylinder 130 even at an initial driving stage and thus the opening/closing operation of the exhaust window is smoothly performed. In addition, the inclination angle of the first rod 110 is adjusted so that the opening/closing angle of the exhaust window can be adjusted to enable to control the amount of air exhausted.

### BRIEF DESCRIPTION OF THE DRAWINGS

The above and other objects, features and advantages of the present invention will be apparent from the following detailed description of the preferred embodiments of the invention when taken in conjunction with the accompanying drawings, in which:

FIG. 1 is a side view illustrating a conventional exhaust window opening/closing device according to the prior art;

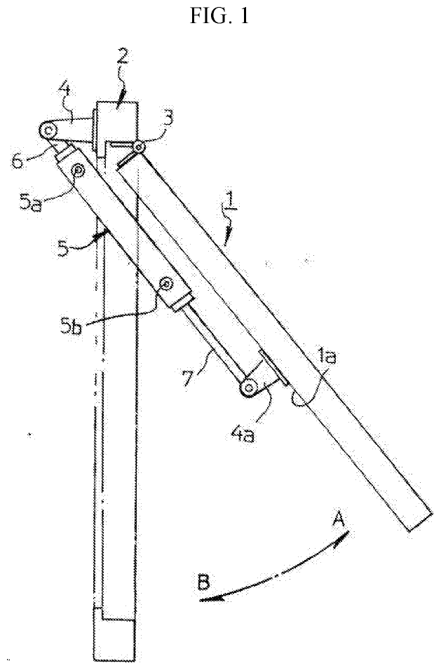

FIG. 2 is a schematic view illustrating a structure of an exhaust window where a quick exhaust device according to the present invention has been installed;

FIGS. 3 and 4 are side views illustrating the operation state of a quick exhaust device according to the present invention;

FIG. 5 is a top perspective view illustrating a quick exhaust device according to the present invention; and

FIG. 6 is a side view illustrating a modification of a quick exhaust device according to the present invention.

### EXPLANATION ON SYMBOLS

101: exhaust port
102: wall
103: exhaust window
104: exhaust fan
110: first rod
115: rotating pin
120: piston rod
130: cylinder
140: first bracket
150: second rod
151: second elongated hole
152: fixing part
160: rotating pin guide plate
161: first elongated hole

### DETAILED DESCRIPTION OF THE PREFERRED EMBODIMENTS

Hereinafter the detailed configuration of a quick exhaust device according to the present invention will be described in detail with reference to the accompanying drawings.

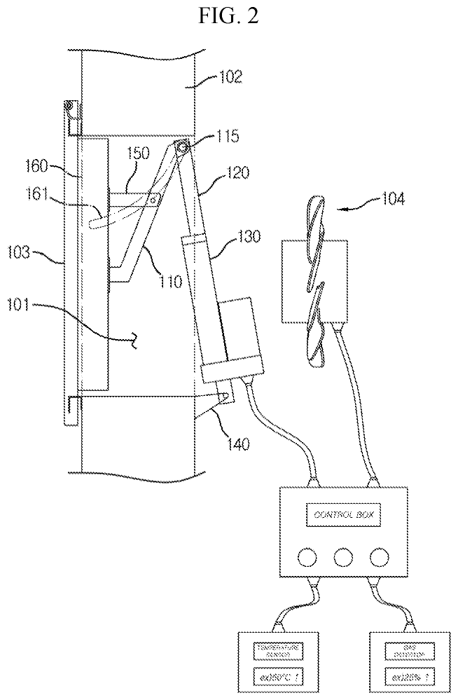

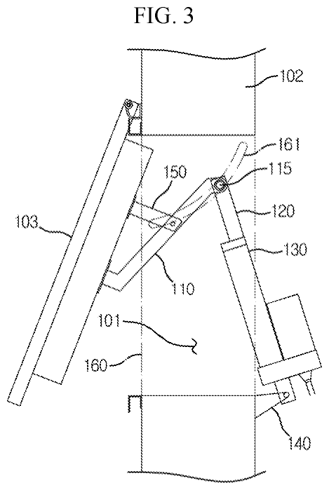

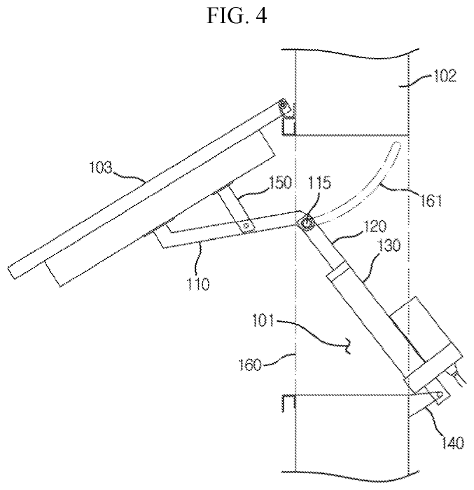

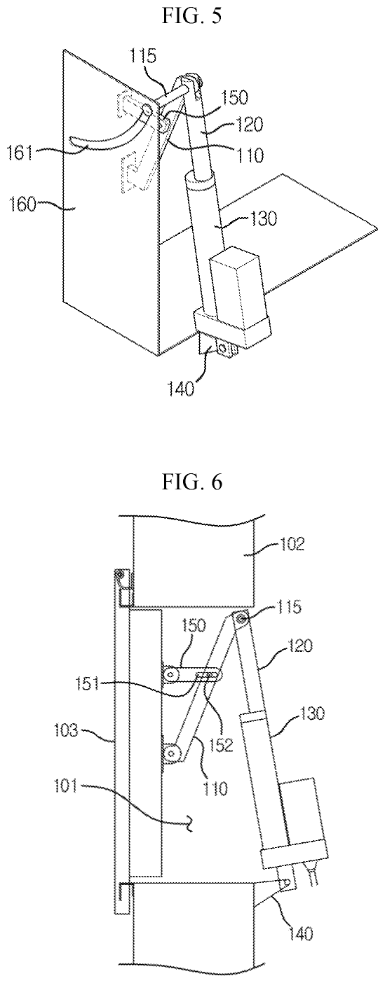

FIG. 2 is a schematic view illustrating a structure of an exhaust window where a quick exhaust device according to the present invention has been installed, FIGS. 3 and 4 are side views illustrating the operation state of a quick exhaust device according to the present invention, FIG. 5 is a top perspective view illustrating a quick exhaust device according to the present invention, and FIG. 6 is a side view illustrating a modification of a quick exhaust device according to the present invention.

An exhaust window is installed to exhaust indoor air of an equipment room to the outside for the purpose of ventilating the equipment room that houses various kinds of mechanical or electrical/electronic devices. The quick exhaust device is configured to automatically open/close an exhaust window 103 in a vertically swivellable manner, the exhaust window being hingedly fixed to an upper portion of an exhaust port 101 disposed on a wall 101. Typically, the exhaust window 103 has a structure in which it is opened outwardly.

Although it has been described above that the exhaust window is opened/closed in the vertically swivellable manner, it can also be opened/closed in a horizontally slidable manner.

The quick exhaust device is installed at one side of the exhaust port 101, and an exhaust fan 104 is installed at the exhaust port 101 in juxtaposition with the quick exhaust device. When the exhaust window 103 is opened by the operation of the quick exhaust device, the exhaust fan 104 is driven to exhaust indoor air of the interior space of an equipment room or the like to the outside.

The quick exhaust device of the present invention includes a first rod 110, a piston rod 120, a cylinder 130, and a first bracket 140 as shown in FIGS. 2 to 5.

The first rod 110 is fixed at one end thereof to an inner lower portion or an inner intermediate portion of the exhaust window 103 and mounted at the other end thereof so as to be upwardly inclined in a direction of being directed toward the inner surface of the exhaust window 103.)

The piston rod 120 is hingedly fixed at an upper end thereof to the other end of the first rod 110 so as to be directed upwardly.

The cylinder 130 is coupled to a lower portion of the piston rod 120 so as to be directed upwardly to allow the piston rod 120 to be withdrawn upwardly from the cylinder 130. The cylinder 130 is configured to allow the piston rod 120 to be inserted thereinto so that the other end of the first rod 110 to which the upper end of the piston rod 120 is hingedly fixed is downwardly swiveled by being pulled downwardly to outwardly push the inner lower portion of the exhaust window 103 to which the one end of the first rod 110 is fixed to thereby open the exhaust window 103. In addition, the cylinder 130 is configured to allow the piston rod 120 to be withdrawn therefrom so that the other end of the first rod 110 to which the upper end of the piston rod 120 is hingedly fixed is upwardly swiveled by being pushed upwardly to inwardly pull the inner lower portion of the exhaust window 103 to which the one end of the first rod 110 is fixed to thereby close the exhaust window 103.

FIG. 2 shows a state in which the exhaust window 103 is closed to clog the exhaust port 101, FIG. 3 shows a state in which the piston rod 120 to be inserted into the cylinder 130 so that the other end of the first rod 110 to which the upper end of the piston rod 120 is hingedly fixed is downwardly swiveled by being pulled downwardly to open the exhaust window 103, and FIG. 4 shows in a state in which the piston rod 120 is maximally inserted into the cylinder 130 to maximally open the exhaust window 103.

The first bracket 140 is fixed at one end thereof to the inner side of the wall 102 positioned at a lower portion of the exhaust port 101 and is hingedly fixed at the other end thereof to a lower portion of the cylinder 130.

By virtue of the above configuration, the quick exhaust device of the present invention has an advantage in that the first rod 110 that is installed inclinedly is pulled downwardly or pushed upwardly by the insertion or withdrawal of the piston rod 120 into or from the cylinder 130 to open or close the exhaust window, so that an overload is not applied to the cylinder 130 even at an initial driving stage and thus the opening/closing operation of the exhaust window is smoothly performed, unlike a conventional opening/closing device.

In addition, preferably, the quick exhaust device of the present invention further include a second rod 150 configured to stably support the first rod 110 that is installed inclinedly. As shown in FIGS. 2 to 5, a quick exhaust device is provided with a second rod 150.

The second rod 150 is fixed at one end thereof to an inner upper portion of the exhaust window 103 in such a manner as to be positioned higher than a position of the exhaust window 103, where the one end of the first rod 110 is fixed, and is fixed at the other end thereof to an intermediate portion of the first rod 110.

The second rod 150 is provided at the quick exhaust device to disperse a force exerted to the first rod 110 so that the first rod 110 can be supported more stably.

Moreover, a horizontal displacement of the hinge-coupled portion between the piston rod 120 and the first rod 110 according to the frequent use of the quick exhaust device may occur. When an abnormal pressure is generated at the cylinder 130 operated by a pneumatic or hydraulic pressure, the swiveling operation of the first rod 110 according to the withdrawal or insertion of the piston rod 120 from or into the cylinder 130 may not be performed smoothly along a normal trajectory.

The quick exhaust device of the present invention further includes a rotating pin 115 and a rotating pin guide plate 160 formed with an arcuate elongated hole so as to stably guide the hinge-coupled portion between the piston rod 120 and the first rod 110 so that the swiveling operation of the first rod 110 according to the withdrawal or insertion of the piston rod 120 from or into the cylinder 130 can be performed smoothly along a normal trajectory.

The rotating pin 115 is formed extending outwardly from a hinged fixing part where the upper end of the piston rod 120 is hingedly fixed to the other end of the first rod 110.

The rotating pin guide plate 160 is fixed to one side of the exhaust port 101 and has a first arcuate elongated hole 161 formed in a shape the same as that of a swiveling trajectory of the first rod 110 according to the withdrawal or insertion of the piston rod 120 from or into the cylinder 130 to allow the rotating pin 115 to be inserted into the first arcuate elongated hole 161 to guide the rotating pin 115 along the swiveling trajectory of the first rod 110. FIG. 5 shows a state in which the rotating pin 115 has been coupled to the first elongated hole 161 of the rotating pin guide plate 160.

The first elongated hole 161 is formed in an arcuate shape corresponding to a swiveling trajectory of the first rod 110, which extends from an inner upper portion of the exhaust port to an inner lower portion thereof and ends in a curved concave shape at a lower end of the first elongated hole 161.

The rotating pin 115 inserted into the first elongated hole 161 is slidably moved along the first elongated hole 161, and thus the swiveling operation of the first rod 110 and the piston rod 120 according to the withdrawal or insertion of the piston rod 120 from or into the cylinder 130 is performed smoothly, so that the opening/closing operation of the exhaust window 103 can be ultimately performed more stably.

A roller (not shown) is preferably disposed at an insertion portion of the rotating pin 115 inserted into the first elongated hole 161.

If the roller is disposed at the insertion portion of the rotating pin 115 inserted into the first elongated hole 161, the slidable movement of the insertion portion of the rotating pin 115 within the first elongated hole 161 can be carried out more smoothly while reducing a friction between the rotating pin 115 and the first elongated hole 161.

The rotating pin guide plate 160 may be configured such that a fixing part where the other end of the second rod 150 is fixed to the intermediate portion of the first rod 110 is slidably guided along the first elongated hole 161

In this case, an extension (not shown) is formed extending outwardly from the fixing part where the other end of the second rod 150 is fixed to the intermediate portion of the first rod 110, and the rotating pin guide plate 160 has an arcuate elongated hole (not shown) formed thereon to allow the extension to be inserted thereinto to slidably guide the extension. Further, a roller (not shown) may be disposed at an insertion portion of the extension inserted into the arcuate elongated hole.

In addition, the quick exhaust device of the present invention is preferably configured such that the opening/closing angle of the exhaust window 103 can be adjusted.

To this end, as shown in FIG. 6, the first rod 110 is hingedly fixed at one end thereof to an inner lower portion or an inner intermediate portion of the exhaust window 103, and the second rod 150 is hingedly fixed at one end thereof to an inner upper portion of the exhaust window 103 and has a second elongated hole 151 formed to a predetermined length in the longitudinal direction thereof at the other end side thereof. In addition, a fixing part 152 where the other end of the second rod 150 and the intermediate portion of the first rod 110 are fixed to each other is slidably moved along the second elongated hole 151 so that the opening/closing angle of the exhaust window 103 can be adjusted.

In FIG. 6, when the fixing part 152 is moved leftwardly along the second elongated hole 151 to fix the second rod 150 and the intermediate portion of the first rod 110, the opening/closing angle of the exhaust window 103 becomes small. On the contrary, when the fixing part 152 is moved rightwardly along the second elongated hole 151 to fix the second rod 150 and the intermediate portion of the first rod 110, the opening/closing angle of the exhaust window 103 becomes large so that the opening/closing angle of the exhaust window 103 can be adjusted smoothly.

While the quick exhaust device according to the present invention have been described and illustrated in connection with specific exemplary embodiments with reference to the accompanying drawings, it will be readily appreciated by those skilled in the art that it is merely illustrative of the preferred embodiments of the present invention and various modifications and changes can be made thereto within the spirit and scope of the present invention, set forth in the claims.

What is claimed is:

1. A quick exhaust device configured to automatically open/close an exhaust window (103) in a vertically swivellable manner, the exhaust window being hingedly fixed to an upper portion of an exhaust port (101) disposed on a wall (101), the exhaust device comprising:
a first rod (110) fixed at one end thereof to an inner lower portion or an inner intermediate portion of the exhaust window (103) and mounted at the other end thereof so as to be upwardly inclined in a direction of being directed toward the inner surface of the exhaust window (103);
a piston rod (120) hingedly fixed at an upper end thereof to the other end of the first rod (110) so as to be directed upwardly;
a cylinder (130) coupled to a lower portion of the piston rod (120) so as to be directed upwardly to allow the piston rod (120) to be withdrawn upwardly from the cylinder (130), wherein the cylinder (130) is configured to allow the piston rod (120) to be inserted thereinto so that the other end of the first rod (110) to which the upper end of the piston rod (120) is hingedly fixed is downwardly swiveled by being pulled downwardly to outwardly push the inner lower portion of the exhaust window (103) to which the one end of the first rod (110) is fixed to thereby open the exhaust window (103), and the cylinder (130) is configured to allow the piston rod (120) to be withdrawn therefrom so that the other end of the first rod (110) to which the upper end of the piston rod (120) is hingedly fixed is upwardly swiveled by being pushed upwardly to inwardly pull the inner lower portion of the exhaust window (103) to which the one end of the first rod (110) is fixed to thereby close the exhaust window (103); and
a first bracket (140) fixed at one end thereof to the inner side of the wall (102) positioned at a lower portion of the exhaust port (101) and hingedly fixed at the other end thereof to a lower portion of the cylinder (130).

2. The quick exhaust device according to claim 1, further comprising a second rod (150) fixed at one end thereof to an inner upper portion of the exhaust window (103) in such a manner as to be positioned higher than a position of the exhaust window (103), where the one end of the first rod (110) is fixed, and fixed at the other end thereof to an intermediate portion of the first rod (110).

3. The quick exhaust device according to claim 2, further comprising:
a rotating pin (115) formed extending outwardly from a hinged fixing part where the upper end of the piston rod (120) is hingedly fixed to the other end of the first rod (110); and
a rotating pin guide plate (160) fixed to one side of the exhaust port (101) and having a first arcuate elongated hole (161) formed in a shape the same as that of a swiveling trajectory of the first rod (110) according to the withdrawal or insertion of the piston rod (120) from or into the cylinder (130) to allow the rotating pin (115) to be inserted into the first arcuate elongated hole (161) to guide the rotating pin (115) along the swiveling trajectory of the first rod (110).

4. The quick exhaust device according to claim 3, wherein a roller is disposed at an insertion portion of the rotating pin (115) inserted into the first elongated hole (161).
